(19) United States
(12) Patent Application Publication
(10) Pub. No.: US 2019/0205777 A1
(43) Pub. Date: Jul. 4, 2019

(54) METHOD AND APPARATUS FOR EVALUATING A USER-SPECIFIED PATH IN AN ACTIVITY

(71) Applicant: KONINKLIJKE PHILIPS N.V., Eindhoven (NL)

(72) Inventors: Björn Nicolaas Servatius VLASKAMP, Eindhoven (NL); Murray Fulton GILLIES, Eindhoven (NL); Laura KLAMING, Amsterdam (NL); Daisy VAN MINDE, EIndhoven (NL)

(73) Assignee: Koninklijke Philips N.V., Eindhoven (NL)

(21) Appl. No.: 16/312,310

(22) PCT Filed: Jul. 3, 2017
(86) PCT No.: PCT/EP2017/066421

§ 371 Date: Dec. 21, 2018

(30) Foreign Application Priority Data
Jul. 1, 2016 (EP) 16177573.9

(51) Int. Cl. G06N 5/04; G06K 9/00; G09B 19/00

(52) U.S. Cl. CPC G06N 5/048; G09B 19/00; G06K 9/00422

(57) ABSTRACT

There is provided a method for evaluating a user-specified path in an activity in which the user is to select a plurality of targets, the method in an electronic device comprising receiving information on a plurality of targets and information on the user-specified path; defining a respective evaluation area for each target; and determining whether the user has successfully selected a first target in the plurality of targets by: determining from the user-specified path an entry point for the user-specified path into the evaluation area for the first target and an exit point for the user-specified path out of the evaluation area for the first target; determining a first measure of similarity being a measure of similarity for the part of the user-specified path in the evaluation area for the first target and a first path that is a straight line from the determined entry point to the determined exit point; determining a second measure of similarity being a measure of similarity for the part of the user-specified path in the evaluation area for the first target and a second path formed from a first straight-line section from the determined entry point to the first target and a second straight-line section from the first target to the determined exit point; and comparing the determined first and second measures of similarity to determine whether the user has successfully selected the first target.

### TECHNICAL FIELD OF THE INVENTION

The invention relates to a method and apparatus for evaluating a user-specified path in an activity in which the user is to select a plurality of targets.

### BACKGROUND TO THE INVENTION

The Trail Making Test (TMT) is a neuropsychological test that is used to assess various aspects of cognitive functioning. The TMT involves asking the participant to draw a line to connect dots together in the correct sequence. These dots, known as targets, are typically printed on paper and the participant is given a pen and asked to connect them in the correct sequence. The TMT typically has two parts. An example of Part A is shown in FIG. 1(a) and an example of Part B is shown in FIG. 1(b). In Part A the participant is presented with 25 numbered targets that they have to connect together in ascending number order. In Part B the participant is presented with targets comprising a sequence of numbers and a sequence of letters that are arranged randomly and the participant has to connect the targets in an alternating manner e.g. 1, A, 2, B, 3, C, . . . .

The time taken to complete each part of the TMT can be recorded and compared to normative data where age and education level are taken into account. The ratio of the time taken to complete Part B over the time taken to complete Part A is considered to be a significant clinical parameter. The ratio is therefore considered to isolate executive functioning.

Typically, the completion of the TMT is monitored by an assessor, for example a healthcare professional, who assesses the accuracy of the participant's efforts, as well as the time elapsed to complete the test. In some cases an assessor may consider a ‘miss’ of a particular target to actually be a ‘hit’ if the line drawn by the participant was ‘close enough’ to hitting the right target. This can make the results of a test subjective, since different assessors may consider these types of mistakes differently (e.g. as a miss instead of a hit), which has an effect on the validity and comparability of the test results.

In addition, a participant may realize that they have made a mistake during the test (e.g. that they have missed out one of the targets in the sequence), and the participant may go back to the last target that was correctly hit and continue the test from there. One test protocol can be for the assessor to inform the participant that they have made a mistake and that they should go back to the target where it was made and make the correct connection. However, this type of mistake means that the total time taken to complete the test may no longer be an accurate reflection of the ability of the participant to complete the test, since it is influenced by the time taken for the assessor to spot the mistake and intervene in the test. This uncontrolled or inconsistent time component compromises the validity of the test.

In view of at least these problems, it is desired to provide an apparatus and method that can reliably assess a participant's efforts in completing a test, or more generally an activity, in which they have to select or connect a plurality of targets, automatically and seamlessly. In furtherance, there is a need for an apparatus and method that enable adequate, reliable and easy assessment of a participant's abilities, such as user's effort and/or cognitive abilities, by means of a test, or more generally an activity.

### SUMMARY OF THE INVENTION

According to a first aspect, there is provided a method for evaluating a user-specified path in an activity in which the user is to select a plurality of targets, the method in an electronic device comprising receiving information on a plurality of targets and information on the user-specified path; defining a respective evaluation area for each target; and determining whether the user has successfully selected a first target in the plurality of targets by: determining from the user-specified path an entry point for the user-specified path into the evaluation area for the first target and an exit point for the user-specified path out of the evaluation area for the first target; determining a first measure of similarity, corresponding to a measure of similarity for the part of the user-specified path in the evaluation area for the first target and a first path that is a straight line from the determined entry point to the determined exit point; determining a second measure of similarity, corresponding to a measure of similarity for the part of the user-specified path in the evaluation area for the first target and a second path formed from a first straight-line section from the determined entry point to the first target and a second straight-line section from the first target to the determined exit point; and comparing the determined first and second measures of similarity to determine whether the user has successfully selected the first target. Thus, the method provides that the user's efforts in completing an activity can be automatically and reliably assessed.

In some embodiments, the step of defining a respective evaluation area for each target comprises: defining an evaluation area for a specific target in the plurality of targets as the area that includes all spatial points whose distance to the specific target is equal to or less than the distance to any other target in the plurality of targets. This embodiment has the advantage that the size of the evaluation areas is dependent on the proximity of the targets to each other, which requires the user to be more accurate when creating a path to select a target that is in a region where the targets are located close to each other.

In alternative embodiments, the step of defining a respective evaluation area for each target comprises: defining an evaluation area for a specific target in the plurality of targets as the area that includes all spatial points within a fixed radius of the specific target. This embodiment has the advantage that the evaluation area for each target is the same size, and the classification of selections as being correct or incorrect by the invention will appear consistent to the user and any assessor.

In alternative embodiments, the step of defining a respective evaluation area for each target comprises: defining an evaluation area for a specific target in the plurality of targets with a boundary that is the smaller of a fixed radius from the center of the specific target and the mid-point from the specific target to the nearest other target in the plurality of targets. This embodiment has the advantage that the size of the evaluation areas is dependent on the proximity of the targets to each other, while ensuring that the evaluation areas do not extend too far from the respective targets

In some embodiments, the steps of determining a measure of similarity comprise one of: (i) determining the sum of the squared distances between samples of the part of the user-specified path in the evaluation area for the first target and the first path and determining the sum of the squared distances between samples of the part of the user-specified path in the evaluation area for the first target and the second path; (ii) determining the sum of the distances between samples of the part of the user-specified path in the evaluation area for the first target and the first path and determining the sum of the distances between sample of the part of the user-specified path in the evaluation area for the first target and the second path; (iii) determining the size of the area bounded by the part of the user-specified path in the evaluation area for the first target and the first path, and determining the size of the area bounded by the part of the user-specified path in the evaluation area for the first target and the second path; and determining the difference in the length of the part of the user-specified path in the evaluation area for the first target and the length of the first path, and determining the difference in the length of the part of the user-specified path in the evaluation area for the first target and the length of the second path.

In some embodiments, the step of comparing the determined first and second measures of similarity comprises determining whether the part of the user-specified path in the evaluation area for the first target more closely matches (i.e. is a better match for) the first path or the second path. In some embodiments, the step of comparing the determined first and second measures of similarity comprises determining that the first target has been successfully selected if the part of the user-specified path in the evaluation area for the first target more closely matches (i.e. is a better match for) the second path than the first path.

In some embodiments, the step of determining whether the user has successfully selected a first target in the plurality of targets further comprises determining whether the user-specified path crosses or touches the first target; and if the user-specified path crosses or touches the first target, determining that the first target has been successfully selected.

In some embodiments, the method further comprising the step of displaying the plurality of targets on a display screen. This embodiment has the advantage that the activity can be implemented using the electronic device or another electronic device.

In some embodiments, the method further comprises the step of controlling the appearance of each target on the display screen based on whether the user has successfully selected said target. This enables the user to see whether they successfully selected the target.

In some embodiments, the method further comprises the step of monitoring the total time taken to select all of the plurality of targets. This total time taken provides the user or an assessor with a measure that can be used to compare the user's performance of the activity over time, or compare the user's performance of the activity to other users.

In some embodiments, the method further comprises the step of subtracting the time taken in respect of targets in the plurality of targets that were not successfully selected from the total time taken. This embodiment means that the total time taken only applies to the correctly selected targets, and thus variability in the time taken by different users to spot and/or correct their errors can be factored out of the total time taken.

In some embodiments, the step of receiving information on a plurality of targets and information on a user-specified path comprises receiving information from a memory unit of the electronic device. This embodiment has the advantage that the evaluation of the user-specified path can be performed at any desired time, for example some time after the user has completed the activity.

In alternative embodiments, the step of receiving information on a plurality of targets and information on a user-specified path comprises receiving the information from a digital scanner or digital camera. This embodiment has the advantage that the user can perform the activity using paper and a pen or pencil.

In alternative embodiments, the step of receiving information on a plurality of targets and information on a user-specified path comprises receiving the information from a user interface of the electronic device. This embodiment has the advantage that the activity can be implemented using an electronic device such as a laptop, tablet or smart phone, and/or that the evaluation can be performed as the user specifies the path.

According to a second aspect, there is provided a computer program product for evaluating a user-specified path in an activity in which the user is to select a plurality of targets comprising a computer readable medium having computer readable code embodied therein, the computer readable code being configured such that, on execution by a suitable computer or processing unit, the computer or processing unit is caused to perform any of methods described above. The computer program product can comprise computer-readable program code downloadable from or downloaded from a communications network, or storable on, or stored on a computer-readable storage medium, which computer-readable program code, when run on a computer or processing unit causes the computer or processing unit to perform the steps of any embodiments of the method in accordance with the present invention. The computer program product can be suitable to work with a system including a server device and a client device. Part of the steps can be performed on the server device while the other or another part of the steps is performed on the client device. The server and client device can be remote from each other and connected through wired or wireless communication as known in the art. Alternatively, all steps are performed on a server device or on a client device. The server device and client device can have communication devices for communicating with each other using wired or wireless communication protocols.

According to a third aspect, there is provided an apparatus for evaluating a user-specified path in an activity in which the user is to select a plurality of targets, the apparatus comprising a processing unit configured to: receive information on a plurality of targets and information on the user-specified path; define a respective evaluation area for each target; and determine whether the user has successfully selected a first target in the plurality of targets by: determine from the user-specified path an entry point for the user-specified path into the evaluation area for the first target and an exit point for the user-specified path out of the evaluation area for the first target; determine a first measure of similarity, corresponding to a measure of similarity for the part of the user-specified path in the evaluation area for the first target and a first path that is a straight line from the determined entry point to the determined exit point; determine a second measure of similarity, corresponding to a measure of similarity for the part of the user-specified path in the evaluation area for the first target and a second path formed from a first straight-line section from the determined entry point to the first target and a second straight-line section from the first target to the determined exit point; and compare the determined first and second measures of similarity to determine whether the user has successfully selected the first target. Thus, the apparatus provides that the user's efforts in completing an activity can be automatically and reliably assessed.

In some embodiments, the processing unit is configured to define a respective evaluation area for each target by defining an evaluation area for a specific target in the plurality of targets as the area that includes all spatial points whose distance to the specific target is equal to or less than the distance to any other target in the plurality of targets. This embodiment has the advantage that the size of the evaluation areas is dependent on the proximity of the targets to each other, which requires the user to be more accurate when creating a path to select a target that is in a region where the targets are located close to each other.

In alternative embodiments, the processing unit is configured to define a respective evaluation area for each target by defining an evaluation area for a specific target in the plurality of targets as the area that includes all spatial points within a fixed radius of the specific target. This embodiment has the advantage that the evaluation area for each target is the same size, and the classification of selections as being correct or incorrect by the invention will appear consistent to the user and any assessor.

In alternative embodiments, the processing unit is configured to define a respective evaluation area for each target by defining an evaluation area for a specific target in the plurality of targets with a boundary that is the smaller of a fixed radius from the center of the specific target and the mid-point from the specific target to the nearest other target in the plurality of targets. This embodiment has the advantage that the size of the evaluation areas is dependent on the proximity of the targets to each other, while ensuring that the evaluation areas do not extend too far from the respective targets

In some embodiments, the processing unit is configured to determine the measures of similarity by one of: (i) determining the sum of the squared distances between samples of the part of the user-specified path in the evaluation area for the first target and the first path and determining the sum of the squared distances between samples of the part of the user-specified path in the evaluation area for the first target and the second path; (ii) determining the sum of the distances between samples of the part of the user-specified path in the evaluation area for the first target and the first path and determining the sum of the distances between sample of the part of the user-specified path in the evaluation area for the first target and the second path; (iii) determining the size of the area bounded by the part of the user-specified path in the evaluation area for the first target and the first path, and determining the size of the area bounded by the part of the user-specified path in the evaluation area for the first target and the second path; and determining the difference in the length of the part of the user-specified path in the evaluation area for the first target and the length of the first path, and determining the difference in the length of the part of the user-specified path in the evaluation area for the first target and the length of the second path.

In some embodiments, the processing unit is configured to compare the determined first and second measures of similarity by determining whether the part of the user-specified path in the evaluation area for the first target more closely matches (i.e. is a better match for) the first path or the second path. In some embodiments, the processing unit is configured to compare the determined first and second measures of similarity by determining that the first target has been successfully selected if the part of the user-specified path in the evaluation area for the first target more closely matches (i.e. is a better match for) the second path than the first path.

In some embodiments, the processing unit is configured to determine whether the user-specified path crosses or touches the first target; and determine that the first target has been successfully selected if the user-specified path crosses or touches the first target.

In some embodiments, the processing unit is further configured to display the plurality of targets on a display screen. This embodiment has the advantage that the activity can be implemented using the apparatus or another electronic device.

In some embodiments, the processing unit is further configured to control the appearance of each target on the display screen based on whether the user has successfully selected said target. This enables the user to see whether they successfully selected the target.

In some embodiments, the processing unit is further configured to monitor the total time taken to select all of the plurality of targets. This total time taken provides the user or an assessor with a measure that can be used to compare the user's performance of the activity over time, or compare the user's performance of the activity to other users.

In some embodiments, the processing unit is further configured to subtract the time taken in respect of targets in the plurality of targets that were not successfully selected from the total time taken. This embodiment means that the total time taken only applies to the correctly selected targets, and thus variability in the time taken by different users to spot and/or correct their errors can be factored out of the total time taken.

In some embodiments, the apparatus is an electronic device.

In some embodiments, the processing unit is configured to receive information on the plurality of targets and information on the user-specified path from a memory unit of the apparatus. In these embodiments, the apparatus can further comprise a memory unit. This embodiment has the advantage that the evaluation of the user-specified path can be performed at any desired time, for example some time after the user has completed the activity.

In alternative embodiments, the processing unit is configured to receive information on the plurality of targets and information on the user-specified path from a digital scanner or digital camera. This embodiment has the advantage that the user can perform the activity using paper and a pen or pencil.

In alternative embodiments, the processing unit is configured to receive information on the plurality of targets and information on the user-specified path from a user interface of the apparatus. The user interface can be a touch screen, a touch pad, a mouse and/or a stylus. In some embodiments, the apparatus can further comprise the user interface. These embodiments have the advantage that the activity can be implemented using an electronic device such as a laptop, tablet or smart phone, and/or that the evaluation can be performed as the user specifies the path.

### BRIEF DESCRIPTION OF THE DRAWINGS

For a better understanding of the invention, and to show more clearly how it may be carried into effect, reference will now be made, by way of example only, to the accompanying drawings, in which:

FIGS. 1(a) and 1(b) show examples of a Trail Making Test;

FIG. 2 is a block diagram of an exemplary apparatus according to an embodiment of the invention;

FIG. 3 is an illustration of an apparatus in the form of a tablet;

FIG. 4 is an illustration of a user specified-path;

FIG. 5 is a flow chart illustrating an exemplary method according to an embodiment;

FIG. 6 is an illustration of a first technique used for evaluating a user-specified path;

FIG. 7 is an illustration of a first technique used for evaluating a user-specified path;

FIG. 8 is a graph illustrating information on the time taken to complete a Trail Making Test; and

FIG. 9 is an example of a Trail Making Test that has been completed by a participant.

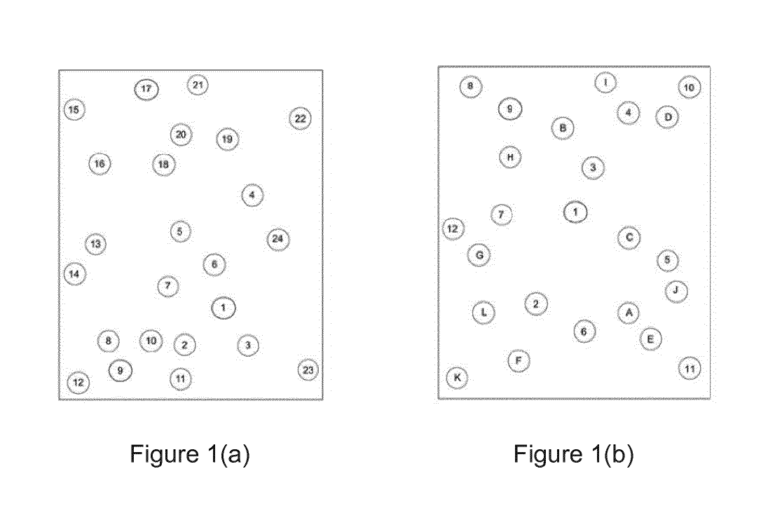

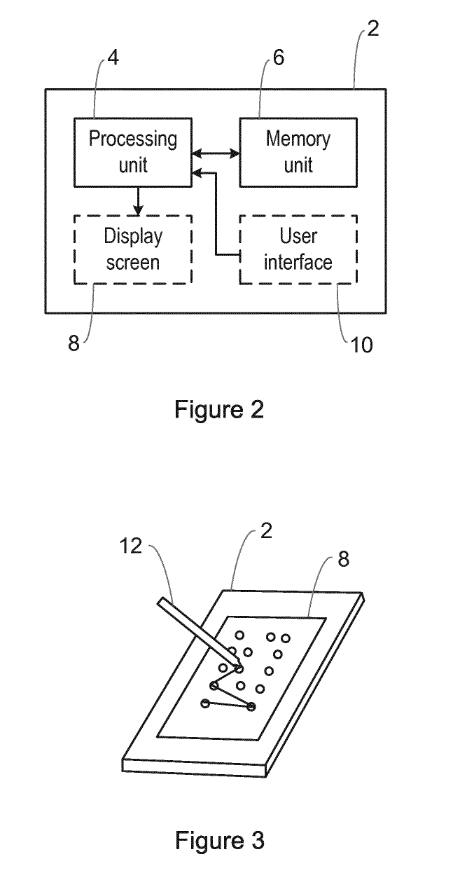

### DETAILED DESCRIPTION OF THE PREFERRED EMBODIMENTS

As noted above, it is desired to provide an apparatus and technique that can automatically and reliably assess a participant's efforts in completing an activity in which they have to select or connect a plurality of targets. A target will be understood as any visible area or region that a user has to hit, highlight, cancel or otherwise select. It will be appreciated that although the invention is described with reference to a Trail Making Test (TMT), the invention is more generally applicable to any type of test game or (more generally) activity in which a participant or user has to specify a path to join, connect, cancel or select a plurality of targets. In some cases, the invention can be applied to assessing a user input in respect of a security feature on an electronic device (e.g. an unlock pattern) in which a user has to draw or indicate a line between a number of targets in a predetermined manner.

It should be noted that the person that is taking part in the activity is referred to herein as the participant or the user.

It will be appreciated from the following description of the invention that it is applicable to a traditional paper-based test, game or other type of activity where a user draws a line using a pen or pencil to connect a plurality of targets shown or printed on the paper, and where the paper is subsequently scanned or otherwise digitized so that it can be assessed or evaluated by the apparatus for accuracy. It is also applicable to an electronic implementation of the test, game or activity where a plurality of targets are shown or projected on a display screen, and the user uses a user interface of the electronic device to input or specify a line or path that connects the targets. In these embodiments the user interface can include a computer mouse, a touchpad or a touchscreen that allows the user to specify the line using their finger or an object, such as a stylus.

FIG. 3 shows a block diagram of an exemplary apparatus according to an embodiment of the invention. The apparatus 2 is an electronic device that comprises a processing unit 4 and a memory unit 6. The processing unit 4 is configured or adapted to control the operation of the apparatus 2 and to implement the techniques according to the invention for assessing a user-specified path in a test in which the user is to select a plurality of targets.

The processing unit 4 can be implemented in numerous ways, with software and/or hardware, to perform the required function(s). The processing unit 4 may comprise one or more microprocessors that may be programmed using software to perform the required functions. The processing unit 4 may be implemented as a combination of dedicated hardware to perform some functions and a processor (e.g., one or more programmed microprocessors and associated circuitry) to perform other functions. Examples of components that may be employed in various embodiments of the present disclosure include, but are not limited to, conventional microprocessors, application specific integrated circuits (ASICs), and field-programmable gate arrays (FPGAs).

The memory unit 6 can store program code that can be executed by the processing unit 4, and for example computer code that can cause or allow the processing unit 4 to implement the techniques according to the invention. The memory unit 6 can also or alternatively store information required during the implementation of the techniques according to the invention, for example information on the plurality of targets, the user-specified path, and/or the results of any assessment or evaluation of the user-specified path. The memory unit 6 can also or alternatively store information on the results of tests previously completed by the user or other users for comparison with the results of the current test. The memory unit 6 can comprise any suitable type of non-volatile or volatile memory, including, but not limited to, magnetic-based storage, such as a hard disk, solid-state memory, or optical-based storage, such as an optical disk.

As noted above, in some embodiments the apparatus 2 is to assess a scanned or digitized image of a paper-based test that is being or has been completed by a user. In that case, the apparatus 2 may include a component (e.g. a digital scanner or digital camera) that can scan or digitize the paper copy of the test or provide a digital video sequence of the user performing the test, and that can store the digitized result in the memory unit 6, or provide the digitized test result to the processing unit 4 for evaluation. In some cases the component may be able to analyze the digitized test result or video sequence to identify lines and/or other content (e.g. the plurality of targets), but in other cases this may be done by the processing unit 4. Alternatively, it will be appreciated that the apparatus 2 can simply receive a digitized result of the test or video sequence from another device (e.g. a remote scanner, remote camera or computer), in which case it can be stored in the memory unit 6 or provided directly to the processing unit 4. Where a video sequence of the paper copy is provided, it is possible to evaluate the results as the user is specifying the path.

Also as noted above, in some embodiments, the apparatus 2 can be used to provide an electronic implementation of the test, game or activity where a plurality of targets are shown or projected on a display screen 8 of the apparatus 2, and the user uses a user interface 10 of the apparatus 2 to input or specify a line or path that connects the displayed targets. In these embodiments the user interface 10 can include any suitable type of device or component that allows a user to specify the line or path, such as a computer mouse, a touchpad or a touchscreen (in which case the display screen 8 and user interface 10 are effectively implemented by the same component). In the case of a touchscreen, the user may be able specify or draw the line using their finger, or alternatively the user can use an object, such as a stylus, to draw the line on the touchscreen.

In other embodiments, the test, game or activity can be presented to the user using an electronic device (e.g. such as a tablet, smartphone, laptop or computer), and the results of the test, game or activity can be communicated to the apparatus 2 for evaluation. In this case, the apparatus 2 can be a computer or other type of electronic device (e.g. a server) that is located remotely from the user, and that could, for example, be used by an assessor, e.g. a healthcare professional.

FIG. 3 is an illustration of an apparatus 2 in the form of a tablet. The tablet 2 comprises a display screen (touchscreen) 8 on which a plurality of targets can be displayed to the user, and the user is provided with a stylus 12 to draw a path connecting or joining the targets together. The processing unit 4 in the tablet 2 can evaluate the path input by the user onto the touchscreen 10, or alternatively the tablet 2 can communicate information on the path input by the user and the plurality of targets to a remote apparatus 2. In the former embodiment, the technique according to the invention can be implemented as part of an application (app) that can be installed on the tablet 2.

It will be appreciated that the apparatus 2 can take alternative forms, for example a smart phone, a laptop, a desktop computer, a television, etc., and FIG. 3 should not be considered limiting.

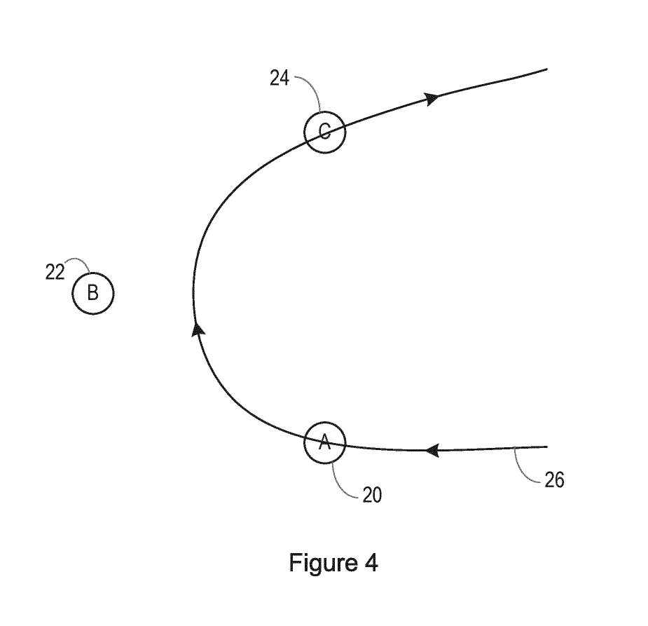

As described above, when a Trail Making Test (TMT) is manually assessed, an assessor may consider a ‘miss’ of a particular target to actually be a ‘hit’ (also known as a ‘cancellation’) if the line drawn by the participant was ‘close enough’ to hitting the right target. This scenario is illustrated in FIG. 4. In FIG. 4 three targets are shown, Target A 20, Target B 22 and Target C 24, and the targets are to be hit or selected in that order (i.e. Target A followed by Target B followed by Target C). In FIG. 4 the user-specified path 26 crosses Target A 20 (i.e. Target A is correctly hit or selected), moves towards Target B 22 but does not cross Target B 22, and then curves around towards, and crosses, Target C 24.

Thus, on a strict interpretation, the user did not correctly select or hit (or cancel) Target B 22 since the user-specified path 26 does not cross Target B 22, and Target B 22 should be considered as having been ‘missed’ or ‘incorrect’ by the user (in which case the user can be required to return to the last successfully hit target and continue, or the fact that a target has been missed can be noted and the number of missed or incorrect targets indicated on completion of the activity). However, in practice it is desirable for certain target misses to be considered as hits (i.e. successful target selections) even though the user-specified path 26 did not cross the displayed target, particularly if the intention of the user to hit or select the correct target is clear from the user-specified path.

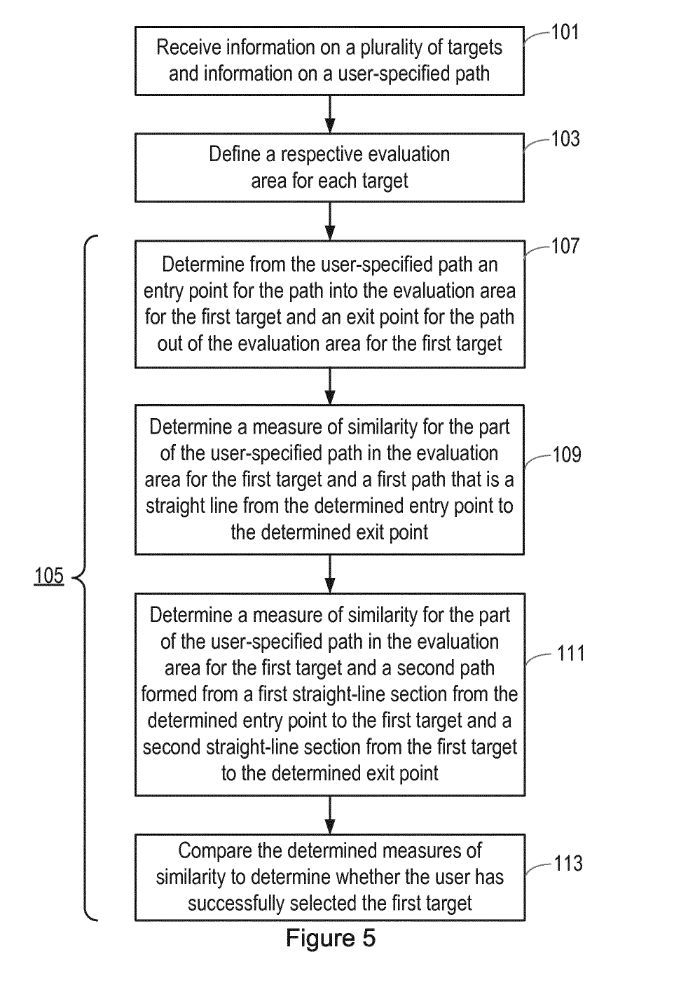

The exemplary method shown in FIG. 5 sets out a technique for reliably and consistently evaluating whether a user has successfully hit or selected (or cancelled) a target in an activity in which the user is to select a plurality of targets. The method can be implemented by apparatus 2, for example by processing unit 4. It will be appreciated from the above that the invention can be applied in real time (i.e. as the user is specifying the path to connect the targets), or applied once the user has completed the activity.

In a first step, step 101, information on a plurality of targets and information on a user-specified path are received. Depending on the implementation of the apparatus 2, the information can be obtained from the memory unit 6, obtained from a user interface component 10, and/or obtained from a scanner or digital camera that is used to digitize a paper copy of the targets and the user-specified path or to provide a video sequence of the paper copy of the targets and the path as it is created by the user.

Thus, the information can be information based on a scanned or imaged copy of a paper-based activity or a video sequence of a paper-based activity, in which case the information comprises information identifying areas that correspond to the targets, the identity of the target (e.g. the number, letter or other identifier associated with each target) and the path specified by the user. It will be appreciated that in the case of a video sequence, it is possible to determine a temporal component of the user-specified path.

Alternatively the information on the user-specified path can be information obtained from the user interface component 10, e.g. a touchscreen, that indicates the path specified by the user, and this information can include a temporal component to the path data (e.g. indicating the time instant at which each part of the path was input by the user). The information on the plurality of targets (e.g. their locations/positions and identity) can be obtained from the information used to drive the display screen 8 to display the plurality of targets. The memory unit 6 may store a plurality of predetermined patterns of targets, in which case the information on the targets can be derived from the information for the particular pattern being displayed on the display screen 8.

In some embodiments, the information on the user-specified path can comprise a plurality of position samples.

It will be appreciated that where the activity is implemented electronically (i.e. the targets are displayed on a display screen 8), the method prior to step 101 can comprise displaying the plurality of targets on a display screen 8 and step 101 can comprise receiving a user input specifying the path via a user interface 10. The user-specified path will also be shown on the display screen 8.

The method also comprises in step 103 defining a respective evaluation area for each of the plurality of targets. The path specified by the user through the evaluation area for a particular target is used in subsequent steps to determine whether the user has successfully selected (i.e. hit or cancelled) that target if the path does not directly cross or touch the target.

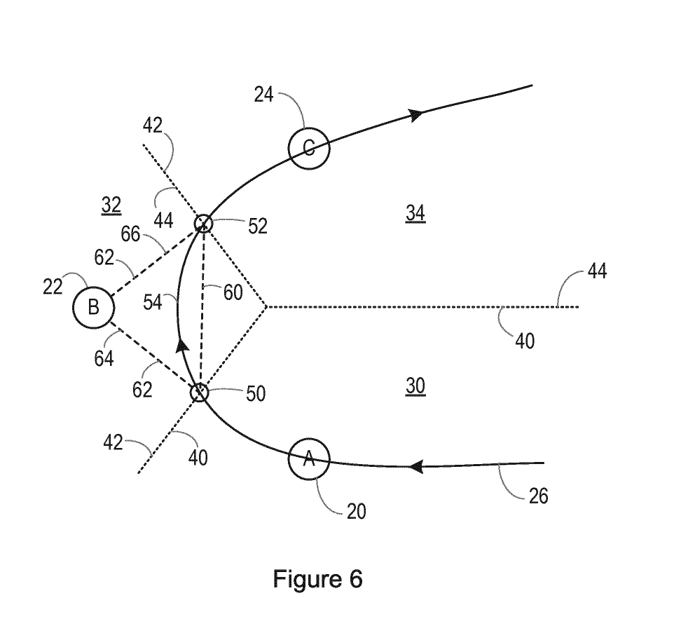

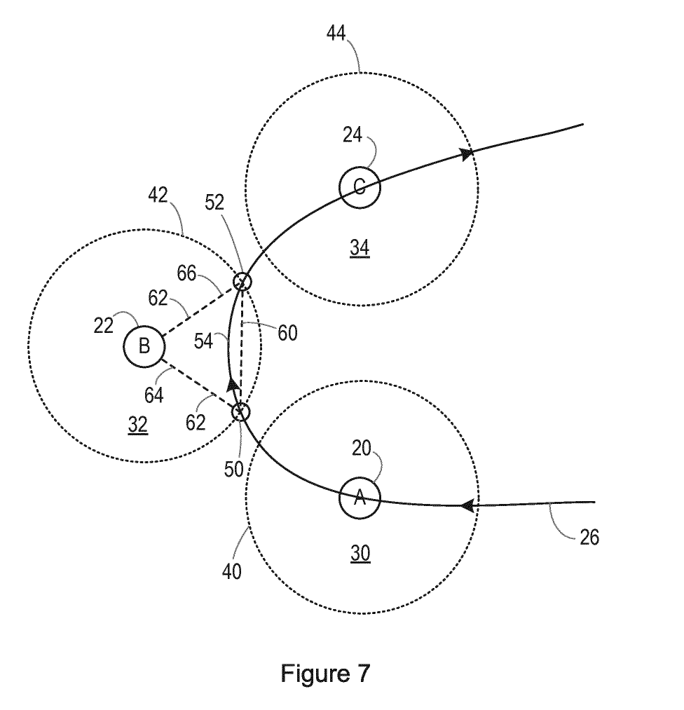

FIGS. 6 and 7 show two different ways in which the evaluation areas can be defined. In FIGS. 6 and 7, evaluation areas 30, 32 and 34 are defined for Target A 20, Target B 22 and Target C 24, that each have respective boundaries 40, 42 and 44.

In some embodiments, as shown in FIG. 6, the boundaries of the evaluation areas 30, 32 and 34 (boundaries 40, 42 and 44 respectively) are defined as the mid-point (in distance) between the two nearest targets. Thus the boundary 40/44 between Target A 20 and Target C 24 is located at the mid-point between Target A 20 and Target C 24. Likewise, the boundary 40/42 between Target A 20 and Target B 22 is located at the mid-point between Target A 20 and Target B 22 and the boundary 42/44 between Target B 22 and Target C 24 is located at the mid-point between Target B 20 and Target C 24.

Put more precisely, an evaluation area for a specific target includes all spatial points whose distance (Euclidean distance) to the specific target is equal to or less than the distance to any other target. It will be appreciated that the evaluation areas determined using this technique form a Voronoi diagram. In these embodiments it will be appreciated that the size of the evaluation area for each target depends entirely on the proximity of the target to other targets, and thus widely spaced targets will tend to have larger evaluation areas than more-closely spaced targets. Such large evaluation areas may be undesirable since it may allow a user-specified path to be some distance from the target and still be deemed a successful hit.

Thus, in alternative embodiments, for example as shown in FIG. 7, the evaluation areas 30, 32 and 34 can be defined as all spatial points within a fixed radius of the respective target. Thus, each evaluation area is a circle with a fixed radius centered on the respective target, and the boundary of the evaluation area corresponds to the circumference of the circle. In these embodiments the evaluation areas 30, 32 and 34 are all the same size, and it is possible for the radius of the evaluation areas to be set based on the size of the displayed activity (e.g. based on the display screen size), or set based on a desired difficulty or accuracy level for the activity (e.g. a smaller radius means that the user has to be more accurate).

It will be appreciated that in the embodiment of FIG. 7, as the evaluation areas are a fixed size, it is possible that two or more evaluation areas may overlap with each other if their respective targets are close to each other (e.g. if the targets are less than twice the radius apart from each other).

In some embodiments this overlap of evaluation areas is acceptable (particularly where the evaluation areas are small), but in other embodiments this overlap can be avoided by forming the evaluation areas using a combination of the techniques shown in FIGS. 6 and 7. In particular, the boundary of an evaluation area for a specific target can be defined as the smaller of a fixed radius from the center of the target and the mid-point from the specific target to the nearest target. Thus, this embodiment will result in the evaluation areas corresponding to shapes in a Voronoi diagram for closely located targets, with each Voronoi shape being limited to a maximum distance from the target (i.e. the radius).

Once information on the user-specified path 26 has been received or obtained (whether or not the user has completed the activity), and the evaluation areas defined, the method comprises determining whether the user has successfully selected a first target in the plurality of targets with the user-specified path 26. This step can be performed regardless of whether the user has completed the activity (i.e. attempted to hit all of the targets). In FIG. 5 this ‘step’ 105 is comprised of four sub-steps 107, 109, 111 and 113.

Thus, in step 107, for a first target (which, for the following discussion of the invention is considered to be Target B 22 in FIGS. 6 and 7), the point at which the user-specified path 26 enters the evaluation area for the first target (i.e. evaluation area 32) is determined and the point at which the user-specified path 26 exits the evaluation area for the first target (i.e. evaluation area 32) is determined. These points are referred to as the entry point and exit point respectively. In the examples of FIGS. 6 and 7, the entry point is labelled point 50 and the exit point is labelled point 52. Put more generally (which is particularly applicable in the case where the direction in which the user specified the path 26 is not clear or known), step 107 determines the points at which the user-specified path 26 crosses the boundary 42 of the evaluation area for the first target (evaluation area 32).

It is possible that there could be multiple entry and exit points for a particular evaluation area (e.g. where the user has actively tried to select a target and then passed close by that target later in the activity, or vice versa), in which case step 107 can comprise examining temporal data for the user-specified path to identify which exit point is associated with which entry point, and also which entry-exit point pair was an attempt to select the target and which was simply passing close to the target.

Next, in steps 109 and 111, the part of the user-specified path 26 within the evaluation area of the first target (which is referred to as part 54) is compared to two other ‘model’ paths/lines to determine measures of similarity between the part 54 and each of the model paths/lines.

In particular, in step 109 the part 54 of the user-specified path 26 in the evaluation area for the first target is compared to a first path 60 that corresponds to a straight line 60 from the determined entry point 50 to the determined exit point 52. The result of this comparison is a measure of the similarity for the part 54 and the first path 60 (also referred to as the first measure of similarity herein). The first path 60 is shown in FIGS. 6 and 7 and represents the shortest path from the entry point 50 to the exit point 52.

The first measure of similarity determined in step 109 can indicate the amount of deviation of the part 54 of the user-specified path 26 from the first path 60.

In some embodiments, the first measure of similarity can be determined as the sum of the squared distances between the part 54 and the first path 60. The distances between the part 54 and the first path 60 can be determined by projecting each sample representing the user specified-path 26 on to the first path 60, with the distance for a particular sample corresponding to the length of the line extending orthogonally from the first path 60 to the particular sample. Alternatively, the distance for a particular sample can correspond to the length of the line extending orthogonally from the part 54 to the first path 60. A distance is determined for each sample in the part 54 of the user-specified path 26, each distance is squared, and the distances summed to determine the measure of similarity. It will be understood that the smaller the sum of the squared distance, the more similar the part 54 is to the first path 60.

In an alternative embodiment, a distance is determined for each sample in the part 54 of the user-specified path 26 from the first path 60, and, provided the distances are absolute distances (i.e. the magnitude of the distance), the distances are summed to determine the first measure of similarity.

In another alternative embodiment, the first measure of similarity can be the size of the area bounded by the part 54 of the user-specified path 26 and the first path 60. Those skilled in the art will be aware of techniques that can be used to determine the area. It will be understood that the smaller the size of the area, the more similar the part 54 is to the first path 60.

In another alternative, the first measure of similarity can be the difference in the length of the part 54 of the user-specified path 26 and the length of the first path 60. It will be understood that the smaller the difference in the lengths, the more similar the part 54 is to the first path 60.

Those skilled in the art will be aware of other ways in which a measure of similarity can be determined for two lines in a plane, and the above techniques should not be considered as limiting.

In step 111, the part 54 of the user-specified path 26 in the evaluation area for the first target is compared to a second path 62 that comprises a first straight-line section 64 from the determined entry point 50 to the first target (Target B 22) and a second straight-line section 66 from the first target (Target B 22) to the determined exit point 52. The result of this comparison is a measure of the similarity for the part 54 and the second path 62 (also referred to as the second measure of similarity herein). The second path 62 is shown in FIGS. 6 and 7 and represents the shortest path from the entry point 50 to the target 22 and from the target 22 to the exit point 52.

The second measure of similarity determined in step 111 can indicate the amount of deviation of the part 54 of the user-specified path 26 from the second path 62. To enable the first and second measures of similarity determined in steps 109 and 111 to be compared to each other in step 113 below, the technique used to determine the first measure of similarity between the part 54 and the first path 60 in step 111 will be the same as that used to determine the second measure of similarity between the part 54 and the second path 62 in step 109.

Thus, in some embodiments, in step 111 the second measure of similarity can be determined as the sum of the distances or sum of the squared distances between the part 54 and the second path 62. It will be understood that the smaller the sum of the distances or sum of the squared distances, the more similar the part 54 is to the second path 62. As noted in the case of the first path 60 above, the distances between the part 54 and the first path 60 can be determined by projecting each sample representing the user specified-path 26 on to the first path 60 (either projecting orthogonally from the second path 62 to the part 54 or projecting orthogonally from the part 54 to the second path 62). In the case of the second path 62, as it comprises two sections 64, 66, the distance can be measured by projecting each sample representing the user specified-path 26 on to the nearest part of the second path 62. Temporal information for the user-specified path 26 can also be taken into account, for example to ensure that no sample is projected on to a position on the second path 62 preceding that of a preceding sample in the part 54 of the path 26.

In an alternative embodiment, in step 111 the second measure of similarity can be the size of the area bounded by the part 54 of the user-specified path 26 and the second path 62. It will be understood that the smaller the size of the area, the more similar the part 54 is to the second path 62.

In another alternative, the second measure of similarity can be the difference in the length of the part 54 of the user-specified path 26 and the length of the second path 62. It will be understood that the smaller the difference in the lengths, the more similar the part 54 is to the second path 62.

Once the two measures of similarity are determined in steps 109 and 111, in step 113 the first and second measures of similarity are compared to determine whether the user should be considered as having successfully selected (or hit or cancelled) the first target (Target B 22).

In particular embodiments, step 113 comprises determining whether the part 54 of the user-specified path 26 in the evaluation area 32 more closely matches the first path 60 or the second path 62. If the part 54 more closely matches (i.e. is more similar to or is a better match for) the second path 62 than the first path 60 then the first target can be deemed to have been successfully selected. Otherwise if the part 54 more closely matches (i.e. is more similar to or is a better match for) the first path 60 than the second path 62 then the first target can be deemed to have been missed.

For example, in the case of the first and second measures of similarity being the sum of the distances or the sum of the squared distances between the part 54 and the respective path 60/62, if the sum of the distances or the sum of the squared distances with the second path 62 is lower than the sum of the distances or sum of the squared distances with the first path 60, then the first target can be deemed to have been successfully selected.

The method can then output an indication of whether the user should be considered as having successfully selected (or hit or cancelled) the first target. This output can be an output from the processing unit 4 or from the apparatus 2, e.g. as an indication to the user or assessor (e.g. a visual and/or audible indication), or the output can be signal that is used by the processing unit 4, another component of the apparatus 2 or another device or apparatus in subsequent processing (e.g. in evaluating the results of a full TMT).

Thus, the method in FIG. 5 provides a reliable and consistent technique for determining if a target has been successfully selected or not.

It will be appreciated that the method in FIG. 5 (and particularly steps 107-113) can be repeated for each target in the activity.

It will also be appreciated that it is not necessary to perform steps 107-113 for targets where the user-specified path 26 crosses or directly touches the first target since they can already be classified as a successful selection be a comparison of the path 26 to the target. Thus, prior to step 107, the method can determine whether the path 26 crosses or touches the first target, and if so, the first target can be deemed to have been successfully selected. In that case, it is not necessary to perform steps 107-113 for that target, and the method can be repeated for the next target. If it is determined that the path 26 does not cross or touch the first target, then steps 107-113 can be performed for the first target as described above.

In the embodiments above where the first and second measure of similarity is determined from a sum of the distances or a sum of the squared distances between the part 54 and the model line 60/62, it can be advantageous to spatially resample the part 54 of the user-specified path 26 since the spatial density of the samples will depend on the speed with which the user specified the path 26. In particular, the user may be slow in some locations (e.g. on or near to targets) which will generate samples with a high spatial density, and fast in other locations (e.g. between targets) which will generate samples with a lower spatial density. This can bias the measure of similarity determined in steps 109 and 111 if a high number of samples occurs closer to one of the model lines 60/62 than the other since this will add a disproportional amount of large residuals to the least close model line 60/62 for that location. Thus, in some embodiments, the part 54 of the user-specified path 26 can be resampled to produce a set of equally-spaced samples. One way in which the part 54 of the user-specified path 26 can be resampled is to fit a curve through the part 54 and take equally-spaced samples from that curve. Another way in which the part 54 of the user-specified path 26 can be resampled is to drop or remove some of the samples in parts of the part 54 in which the sample spatial density is higher.

In some embodiments, the comparison of the part 54 of the user-specified path 26 to the model lines 60/62 can be enhanced to include temporal properties. In particular, if a target has been intentionally selected by the user, then it would be expected that two movements would be detectable, one towards the target and one away from the target, with the velocity decreasing close to the selected target (e.g. as the user searches for the next target to select). Thus, the part 54 of the user-specified path 26, including the temporal properties of the part 54 (e.g. the times or relative times at which the samples were taken) can be compared to the model lines 60/62 (e.g. by determining a measure of similarity as described above) to determine which is the closest match to the part 54, and thus whether the target should be deemed to have been successfully selected. Alternatively, if the first and second measures of similarity for the part 54 and the spatial-based model lines 60/62 are the same as or close to each other (for example within a threshold value of each other), the temporal properties of the part 54 of the user-specified path 26 can be compared to the temporal properties of the model lines 60/62 to determine if the target should be considered to be successfully selected or not.

In some embodiments, where the activity is displayed on a display screen 8, the processing unit 4 can control the appearance of each target based on whether the target is deemed to have been successfully selected or hit. For example, the appearance of the target can be changed if it is deemed to have been selected by the user (e.g. it can be dimmed in brightness or the color changed).

In some embodiments, each of the plurality of targets has a respective identifier (e.g. a number, letter or other symbol), and the user is to select the targets in a predetermined sequence (e.g. in numerical order, in alphabetical order, in alternating alphabetical and numerical order). In these embodiments, the processing unit 4 can check whether the user has selected the targets in the correct order. If the processing unit 4 determines that the user has not selected the targets in the correct order, the processing unit 4 can provide an indication to the user. Where the activity is being performed using the apparatus 2, the indication can be provided during the performance of the activity so that the user has a chance to correct the mistake (e.g. by returning to the last correctly selected target and continuing the path 26 from there). This indication can be provided to the user or to an assessor, e.g. a healthcare professional.

In some embodiments, the processing unit 4 can monitor the time taken to complete the activity, and can monitor the time taken for the user to complete each part of the user-specified path (e.g. the part between each target). The time taken to complete the activity (and/or each part of the activity) can be output on the display screen 8 or via another electronic device at the end of the activity. The processing unit 4 can also monitor a ‘dwell time’ which is the time that the user dwells on a successfully selected target while visually searching for the next target (and likewise these dwell times can be output at the end of the activity).

If after a user has missed a target the user realizes their mistake and goes back and selects the correct target, the processing unit 4 can take this error into account when monitoring the time taken to complete the activity. For example, the processing unit 4 can subtract the time associated with the mistake(s) from the total time taken to complete the activity. Thus, any time spent on selecting incorrect targets will be disregarded. In this case, if the total time taken is to be compared to the time taken by other users (or a previous attempt of the user), then the total time taken in respect of the correctly selected targets can be compared to the total time taken by other users for the same set of targets. This enables a valid comparison to be made to earlier results, and also overcomes the issue with conventional techniques where the time taken by an assessor to intervene after a mistake has been made affects the total time taken to complete the activity.

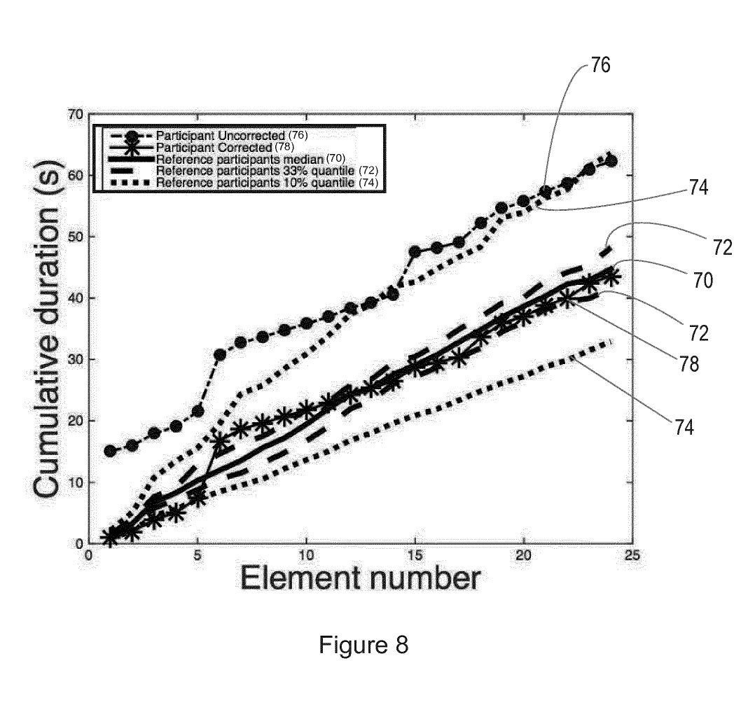

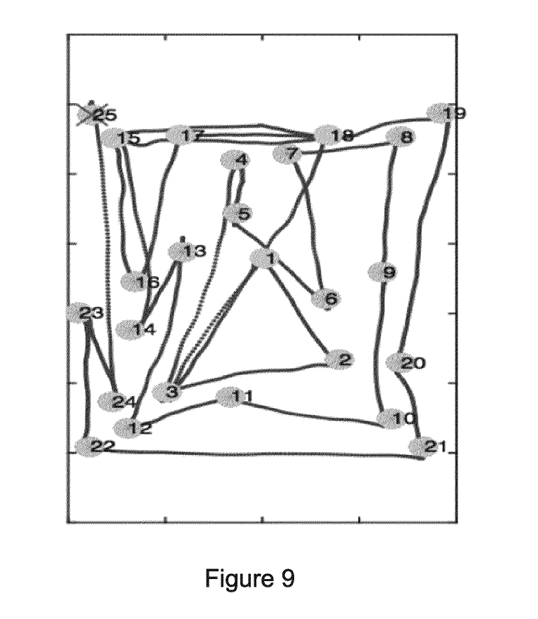

The above total time correction embodiment has been tested on a group of healthy individuals that were each required to complete a TMT Part A test. The graph in FIG. 8 illustrates information on the time taken to complete the TMT, and in particular cumulative TMT durations. The graph shows the time taken to arrive at each of the 25 targets. The solid line 70 represents the distribution of 103 healthy individuals who performed the TMT correctly. The solid line 70 is the median of the distribution, and the dashed lines 72 and the dotted lines 74 are the 33% and 10% cuts of the distribution. The dot-dashed line 76 represents the TMT duration for one healthy participant who made errors (the path specified by this participant is shown in FIG. 9, and errors at targets 1 and 15 can be seen). After the participant made the errors, the participant had to go back to the last correct target and continue the test. The dot-dashed line 76 only shows the cumulative durations for correctly connected elements; the time spent on incorrect targets can be seen as additional time spent on the last correctly cancelled target. This participant started incorrectly (which is why the dot-dashed line 76 starts at ˜15 seconds) and the participant made another error at target 15 (here, a slight jump in duration relative to the other participants can be seen). Because of these errors, this participant's performance is among the slowest 10% (since it is above the 10^{th} quartile line 74).

However, the total time taken by the participant in FIG. 9 can be corrected as described above to only include the time spent on correct targets. The starred line 78 in FIG. 8 shows the cumulative TMT duration for the participant after correcting for the two errors made. Now, the participant's performance is very close to the median and this participant is no longer among the slowest.

There is therefore provided an apparatus and technique that can automatically and reliably assess a participant's efforts in selecting or connecting a plurality of targets.

Variations to the disclosed embodiments can be understood and effected by those skilled in the art in practicing the claimed invention, from a study of the drawings, the disclosure and the appended claims. In the claims, the word “comprising” does not exclude other elements or steps, and the indefinite article “a” or “an” does not exclude a plurality. A single processor or other unit may fulfil the functions of several items recited in the claims. The mere fact that certain measures are recited in mutually different dependent claims does not indicate that a combination of these measures cannot be used to advantage. A computer program may be stored/distributed on a suitable medium, such as an optical storage medium or a solid-state medium supplied together with or as part of other hardware, but may also be distributed in other forms, such as via the Internet or other wired or wireless telecommunication systems. Any reference signs in the claims should not be construed as limiting the scope.

1. A method for evaluating a user-specified path in an activity in which the user is to select a plurality of targets, the method in an electronic device comprising:
receiving information on a plurality of targets and information on the user-specified path;
defining a respective evaluation area for each target; and
determining whether the user has successfully selected a first target in the plurality of targets by:
determining from the user-specified path an entry point for the user-specified path into the evaluation area for the first target and an exit point for the user-specified path out of the evaluation area for the first target;
determining a first measure of similarity, corresponding to a measure of similarity for the part of the user-specified path in the evaluation area for the first target and a first path that is a straight line from the determined entry point to the determined exit point;
determining a second measure of similarity, corresponding to a measure of similarity for the part of the user-specified path in the evaluation area for the first target and a second path formed from a first straight-line section from the determined entry point to the first target and a second straight-line section from the first target to the determined exit point; and
comparing the determined first and second measures of similarity to determine whether the user has successfully selected the first target.

2. A method as claimed in claim 1, wherein the step of defining a respective evaluation area for each target comprises:
defining an evaluation area for a specific target in the plurality of targets as the area that includes all spatial points whose distance to the specific target is equal to or less than the distance to any other target in the plurality of targets.

3. A method as claimed in claim 1, wherein the step of defining a respective evaluation area for each target comprises:
defining an evaluation area for a specific target in the plurality of targets as the area that includes all spatial points within a fixed radius of the specific target.

4. A method as claimed in claim 1, wherein the step of defining a respective evaluation area for each target comprises:
defining an evaluation area for a specific target in the plurality of targets with a boundary that is the smaller of a fixed radius from the center of the specific target and the mid-point from the specific target to the nearest other target in the plurality of targets.

5. A method as claimed in claim 1, wherein the steps of determining a measure of similarity comprise one of:
(i) determining the sum of the squared distances between samples of the part of the user-specified path in the evaluation area for the first target and the first path and determining the sum of the squared distances between samples of the part of the user-specified path in the evaluation area for the first target and the second path;
(ii) determining the sum of the distances between samples of the part of the user-specified path in the evaluation area for the first target and the first path and determining the sum of the distances between sample of the part of the user-specified path in the evaluation area for the first target and the second path;
(iii) determining the size of the area bounded by the part of the user-specified path in the evaluation area for the first target and the first path, and determining the size of the area bounded by the part of the user-specified path in the evaluation area for the first target and the second path; and
(iv) determining the difference in the length of the part of the user-specified path in the evaluation area for the first target and the length of the first path, and determining the difference in the length of the part of the user-specified path in the evaluation area for the first target and the length of the second path.

6. A method as claimed in claim 1, wherein the step of comparing the determined first and second measures of similarity comprises determining whether the part of the user-specified path in the evaluation area for the first target more closely matches the first path or the second path.

7. A method as claimed in claim 6, wherein the step of comparing the determined first and second measures of similarity comprises determining that the first target has been successfully selected if the part of the user-specified path in the evaluation area for the first target more closely matches the second path than the first path.

8. A computer program product comprising a computer readable medium having computer readable code embodied therein, the computer readable code being configured such that, on execution by a suitable computer or processing unit, the computer or processing unit is caused to perform the method of claim 1.

9. An apparatus for evaluating a user-specified path in an activity in which the user is to select a plurality of targets, the apparatus comprising a processing unit configured to:
receive information on a plurality of targets and information on the user-specified path;
define a respective evaluation area for each target; and
determine whether the user has successfully selected a first target in the plurality of targets by:
determine from the user-specified path an entry point for the user-specified path into the evaluation area for the first target and an exit point for the user-specified path out of the evaluation area for the first target;
determine a first measure of similarity, corresponding to a measure of similarity for the part of the user-specified path in the evaluation area for the first target and a first path that is a straight line from the determined entry point to the determined exit point;
determine a second measure of similarity, corresponding to a measure of similarity for the part of the user-specified path in the evaluation area for the first target and a second path formed from a first straight-line section from the determined entry point to the first target and a second straight-line section from the first target to the determined exit point; and
compare the determined first and second measures of similarity to determine whether the user has successfully selected the first target.

10. An apparatus as claimed in claim 9, wherein the processing unit is configured to define a respective evaluation area for each target by:
defining an evaluation area for a specific target in the plurality of targets as the area that includes all spatial points whose distance to the specific target is equal to or less than the distance to any other target in the plurality of targets.

11. An apparatus as claimed in claim 9, wherein the processing unit is configured to define a respective evaluation area for each target by:
defining an evaluation area for a specific target in the plurality of targets as the area that includes all spatial points within a fixed radius of the specific target.

12. An apparatus as claimed in claim 9, wherein the processing unit is configured to define a respective evaluation area for each target by:
defining an evaluation area for a specific target in the plurality of targets with a boundary that is the smaller of a fixed radius from the center of the specific target and the mid-point from the specific target to the nearest other target in the plurality of targets.

13. An apparatus as claimed in claim 9, wherein the processing unit is configured to determine a measure of similarity by one of:
(i) determining the sum of the squared distances between samples of the part of the user-specified path in the evaluation area for the first target and the first path and determining the sum of the squared distances between samples of the part of the user-specified path in the evaluation area for the first target and the second path;
(ii) determining the sum of the distances between samples of the part of the user-specified path in the evaluation area for the first target and the first path and determining the sum of the distances between sample of the part of the user-specified path in the evaluation area for the first target and the second path;
(iii) determining the size of the area bounded by the part of the user-specified path in the evaluation area for the first target and the first path, and determining the size of the area bounded by the part of the user-specified path in the evaluation area for the first target and the second path; and
(iv) determining the difference in the length of the part of the user-specified path in the evaluation area for the first target and the length of the first path, and determining the difference in the length of the part of the user-specified path in the evaluation area for the first target and the length of the second path.

14. An apparatus as claimed in claim 9, wherein the processing unit is configured to compare the determined first and second measures of similarity by determining whether the part of the user-specified path in the evaluation area for the first target more closely matches the first path or the second path.

15. An apparatus as claimed in claim 14, wherein the processing unit is configured to determine that the first target has been successfully selected if the part of the user-specified path in the evaluation area for the first target more closely matches the second path than the first path.

16. A method as claimed in claim 2, wherein the steps of determining a measure of similarity comprise one of:
(i) determining the sum of the squared distances between samples of the part of the user-specified path in the evaluation area for the first target and the first path and determining the sum of the squared distances between samples of the part of the user-specified path in the evaluation area for the first target and the second path;
(ii) determining the sum of the distances between samples of the part of the user-specified path in the evaluation area for the first target and the first path and determining the sum of the distances between sample of the part of the user-specified path in the evaluation area for the first target and the second path;
(iii) determining the size of the area bounded by the part of the user-specified path in the evaluation area for the first target and the first path, and determining the size of the area bounded by the part of the user-specified path in the evaluation area for the first target and the second path; and
(iv) determining the difference in the length of the part of the user-specified path in the evaluation area for the first target and the length of the first path, and determining the difference in the length of the part of the user-specified path in the evaluation area for the first target and the length of the second path.

17. A method as claimed in claim 3, wherein the steps of determining a measure of similarity comprise one of:
(i) determining the sum of the squared distances between samples of the part of the user-specified path in the evaluation area for the first target and the first path and determining the sum of the squared distances between samples of the part of the user-specified path in the evaluation area for the first target and the second path;
(ii) determining the sum of the distances between samples of the part of the user-specified path in the evaluation area for the first target and the first path and determining the sum of the distances between sample of the part of the user-specified path in the evaluation area for the first target and the second path;
(iii) determining the size of the area bounded by the part of the user-specified path in the evaluation area for the first target and the first path, and determining the size of the area bounded by the part of the user-specified path in the evaluation area for the first target and the second path; and
(iv) determining the difference in the length of the part of the user-specified path in the evaluation area for the first target and the length of the first path, and determining the difference in the length of the part of the user-specified path in the evaluation area for the first target and the length of the second path.

18. The computer program product of claim 8, wherein the step of defining a respective evaluation area for each target further comprises defining an evaluation area for a specific target in the plurality of targets as the area that includes all spatial points whose distance to the specific target is equal to or less than the distance to any other target in the plurality of targets.

19. The computer program product of claim 8, wherein the step of defining a respective evaluation area for each target comprises defining an evaluation area for a specific target in the plurality of targets as the area that includes all spatial points within a fixed radius of the specific target.

20. The computer program product of claim 8, wherein the step of defining a respective evaluation area for each target comprises defining an evaluation area for a specific target in the plurality of targets with a boundary that is the smaller of a fixed radius from the center of the specific target and the mid-point from the specific target to the nearest other target in the plurality of targets.
